(19) United States
(12) Patent Application Publication
(10) Pub. No.: US 2006/0197296 A1
(43) Pub. Date: Sep. 7, 2006

(54) Shopping cart with trailing end brake kit

(76) Inventors: Robert Kendrich Rice, Covington, GA (US); Daniel Arthur Dees, Oxford, GA (US)

Correspondence Address: Robert K. Rice, 165 Somerset Dr., Covington, GA, 30016, US

(21) Appl. No.: 11/073,880

(22) Filed: Mar. 7, 2005

(51) Int. Cl. B62D 39/00

(52) U.S. Cl. 280/33.994

(57) ABSTRACT

A shopping cart with the trailing end brake kit, includes a trailing end brake installed on each rear wheel of the shopping cart. The trailing end brake kit can be easily installed on any existing shopping cart in the field. The trailing end brake kit has a brake lever with an ON and OFF position, which is operated by their foot. To unlock the shopping cart's wheels, the operator must lift up the lever in the OFF position with the foot to disengage the lock on the wheels. To lock the shopping cart's rear wheels, the operator must push the lever to the ON position with their foot to prevent the shopping cart rear wheels from moving.

### TITLE OF INVENTION

Shopping cart with trailing end brake kit

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to a shopping cart being incorporated with a trailing end brake kit which gives the operator the choice to lock the shopping carts during loading and unloading and unattended position.

Shopping carts are highly used in retail and grocery stores. The shopping carts can be made of plastic or metal wire basket. The shopping carts are used to transport goods, children, and pets to and from the store and parking lot.

Currently, shopping carts do not have brakes, which develop many problems. When loading a child into a shopping cart, it can be very difficult because the shopping cart is constantly moving while loading your child in the cart seat. Thus, it is not uncommon for a person to keep their hand or foot on the shopping cart or place the shopping cart against an automobile to keep the shopping cart from rolling off into traffic. When the shopping carts are unattended in the parking lot due to incline and unleveled surfaces, the shopping carts roll into automobiles, which may cause stores to be liable for damages.

The shopping cart with brakes has been attempted before, but it was not successful. It was proven to be complicated and to many moving parts. Also, some brakes on the shopping cart were unsafe because shoppers'clothes and fingers can get entangled in the brake parts.

The brakes on the shopping cart needs to be simple, easy to install, user friendly, affordable, durable, and comply with no interference during storage of shopping carts. The trailing end brake kit meets all these needs and more.

### SUMMARY OF THE INVENTION

The shopping cart with the trailing end brake kit allows the customer to lock the shopping cart in a stationary position and unlock the shopping cart to be mobile. The trailing end brake kit gives the operator the choice to be safe when loading and unloading the shopping cart on a sloped parking lot. The trailing end brake kit, also give the operator a great sense of security for their children during loading, unloading, and brief absence. The trailing end brake kit is very simple, user friendly, affordable, durable, and comply with no interference during storage of shopping carts.

The trailing end brake kit can be installed within minutes on any existing shopping cart. The trailing end brake consists of a pre assembly kit with a brake lever operated by the operator's foot. The trailing end brake kit is installed between the caster fork with the axle going through caster fork, brake kit, and wheel with the lock nut on the opposite side of the caster fork.

### DESCRIPTION OF THE SEVERAL VIEWS OF THE DRAWINGS

FIG. 1 is a side view of the trailing end brake kit with the brake lever in the unlock or OFF position.

FIG. 2 is the front view of the trailing end brake kit.

FIG. 3 is the top view of the trailing end brake kit with the text, ON and OFF, on the brake lever.

FIG. 4 is a side view of the trailing end brake kit with the brake lever in the lock or ON position.

FIG. 5 is an exploded 3 dimensional view of the trailing end brake kit as installed on the shopping cart rear wheel.

FIG. 6 is a side view of the trailing end brake kit in the unlocked or OFF position of the present invention with the shopping cart rear wheel unlocked and mobile.

FIG. 7 is a side view of the trailing end brake kit in the locked or ON position of the present invention with the shopping cart rear wheel locked and stationary.

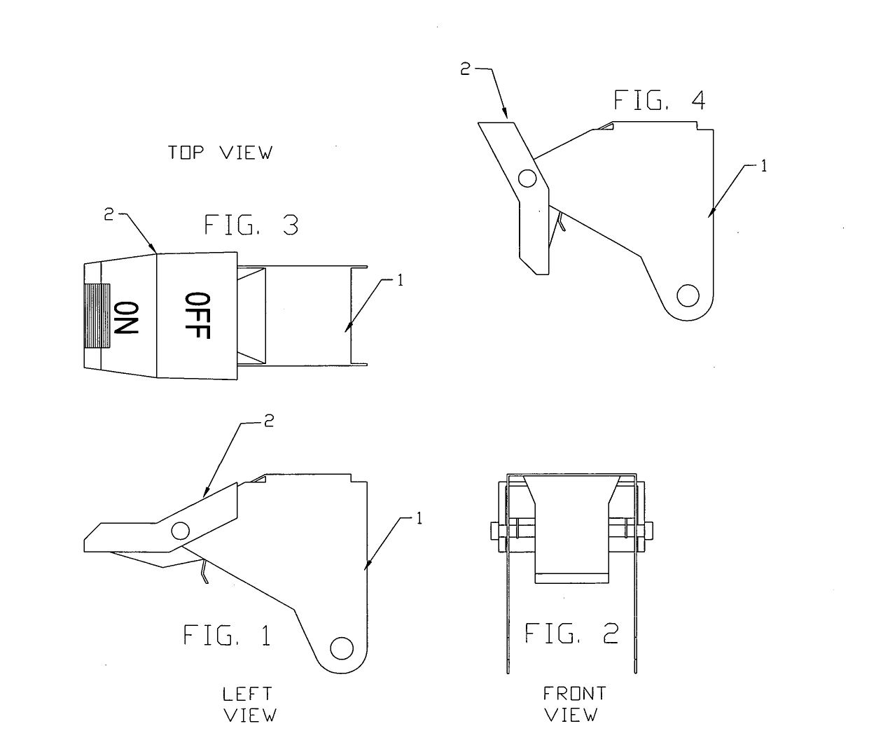

### DETAILED DESCRIPTION OF THE INVENTION

The disclosures made herein relates to a shopping cart with trailing end brake kit that gives the shopper the opportunity to lock and unlock the shopping cart rear wheel with the shoppers'foot, during loading and unloading and to prevent unattended shopping carts from rolling unintentionally.

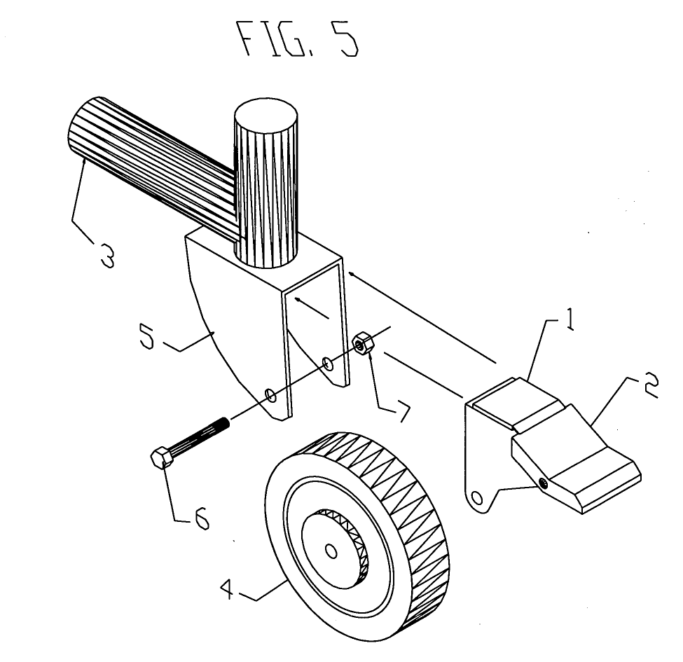

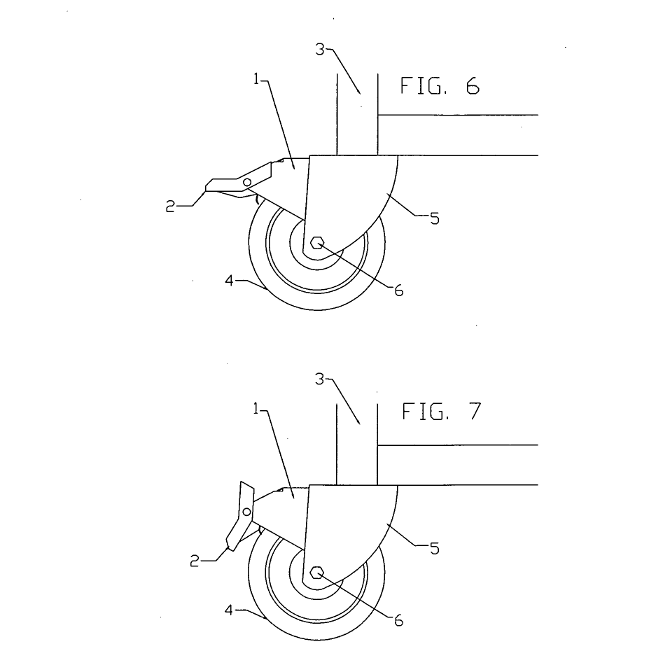

In more details to specific drawings, FIG. 1, FIG. 3, FIG. 4, FIG. 5, FIG. 6, and FIG. 7. depict a trailing end brake kit 1 and a brake lever 2. The brake lever 2 has two positions a lock or ON position and an unlock or OFF position.

In FIG. 5 it represents how to install the trailing end brake kit 1 on the shopping cart rear wheel frame assembly 3. Remove the axle 6 and the wheel 4 from the shopping cart rear wheel fork 5 and install the trailing end brake kit 1 inside the shopping cart rear wheel fork 5 and insert the axle 6 through the wheel fork 5, trailing end brake kit 1, and wheel 4, and fasten a lock nut 7 to axle 6.

In FIG. 6 it represents the shopping cart rear wheel frame assembly 3 with the trailing end brake kit 1 mounted to the shopping cart rear wheel fork 5 and the wheel 4 on the axle 6. The brake lever 2 is in the unlock or OFF position to allow the shopping cart rear wheel 4 to rotate and be mobile.

In FIG. 7 it represents the shopping cart rear wheel frame assembly 3 with the trailing end brake kit 1 mounted to the shopping cart rear wheel fork 5 and the wheel 4 on the axle 6. The brake lever 2 is in the lock or ON position to allow the shopping cart rear wheel 4 to stop rotating and be stationary.

In the preceding detailed description, reference has been made to comply with the drawings for the purpose of illustration. It is intended to cover such modifications without departing from the scope and spirit of the invention. The invention is not to be limited, except as by the appended claims.

1. What we claim as our invention is: A shopping cart with a trailing end brake kit mounted on each rear wheel axle.

2. The shopping cart trailing end brake kit of claim 1, includes the trailing end brake kit with a brake lever facing toward the operator with an ON position for locking and an OFF position for unlocking the shopping cart rear wheels with the operator's foot.
